(19) United States
(12) Patent Application Publication
(10) Pub. No.: US 2003/0036482 A1
(43) Pub. Date: Feb. 20, 2003

(54) Processing of magnesium-boride superconductors

(75) Inventors: Cornelis L. Thieme, Westborough, MA (US); Alexander Otto, Chelmsford, MA (US); Gilbert N. Riley JR., Marlborough, MA (US); Qi Li, Marlborough, MA (US); Yibing Huang, Northborough, MA (US)

Correspondence Address: HALE AND DORR, LLP, 60 STATE STREET, BOSTON, MA, 02109

(73) Assignee: American Superconductor Corporation, Westborough, MA (US)

(21) Appl. No.: 10/190,268

(22) Filed: Jul. 3, 2002

Related U.S. Application Data
(60) Provisional application No. 60/303,058, filed on Jul. 5, 2001.

(51) Int. Cl. H01B 1/00

(52) U.S. Cl. 505/100

(57) ABSTRACT

A method of making a high density Mg—B superconducting article includes providing a packed powder sheath, said powder comprising a source of magnesium and boron, subjecting the packed powder sheath to a symmetric deformation, said deformation selected to elongate the packed powder sheath to form a wire while retaining the free flow of particles within the powder core, subjecting the wire to high reduction rolling, said high reduction rolling selected to reduce the wire thickness by 40 to 95% and heating the rolled article to improve the superconducting properties of the article. A superconducting article comprised of one or more elongated metal matrix regions containing one or more embedded elongated superconducting Mg—B regions running the full length of the article is disclosed, wherein the superconducting Mg—B regions have a density greater than 95 % of the theoretical density, and a transition temperature in zero field of 30 K.

### RELATED APPLICATIONS

This application claims priority under 35 U.S.C. §119(e) to U.S. Ser. No. 60/303,058, filed Jul. 5, 2001, all entitled “Processing of Magnesium-Boride Superconductors,” which is hereby incorporated in its entirety by reference.

### BACKGROUND OF THE INVENTION

The invention relates to magnesium boride superconductors. In particular, it relates to the processing of magnesium boride into superconducting wires.

Although magnesium boride (MgB₂), a hexagonal, layered compound, has been known for years, its superconducting properties have only been recently discovered by J. Akimitsu et al. (Symposium on Transition Metal Oxides, Sendai, Japan, Jan. 10, 2001). The recent discovery of superconductivy at about 39K has produced a high level of activity directed to characterizing MgB₂ in more detail and to synthesizing the superconductor in bulk form. MgB₂ behaves in many ways like a classic BCS superconductor with a relatively low irreversibility field. MgB₂ is an interesting superconducting material due to its strongly linked current flow, even though it has a relatively low H_{c2}(0) and only a modest critical temperature, T_{c}. The irreversibility field parallel to the c-axis is between 2 and 4 T at 25 K, and therefore MgB₂ will be bested suited for applications at operating temperature and field ranges of less than about 30 K (e.g., 15 to 30K) and less than about 3 T (e.g., 0-3T), respectively. Both monofilament and multifilamentary wires are attractive additions to the available superconducting wires. Multifilament wire desirably is capable of being twisted and cabled.

Takano et al. prepared bulk samples by hot pressing, and found considerable differences with sintering temperatures between 775° C. and 1000° C. (Preprint). Transitions were much sharper in the sample pressed at 1000° C. than the one pressed at 775° C., and the normal state resistivity was much lower. The M-H curves at 10K through 35K also showed much higher critical currents for the 1000° C. sample. Critical current densities (J_{c}) derived from these M-H curves were typically an order of magnitude lower than those in the powder and were 400 A/mm² at 20K, 1T. The upper critical field was estimated to be over 25T.

MgB₂ is typically formed by heating magnesium and boron in a sealed tantalum-lined ampoule at high temperatures (950° C.) (Bud'ko et al., Preprint; and Bianconi et al., Preprint). Takano et al. prepared bulk samples by hot pressing, and found considerable differences with sintering temperatures between 775° C. and 1000° C. (Preprint, Mar. 9, 2001, xxx.lanl.gov/abs/cond-mat). Liquid magnesium is chemically aggressive and will react with almost any oxide due to the high stability of MgO. Lower reaction temperatures are desired to reduce reaction of the reactive components with their environment.

Among the more useful known low temperature superconductor (LTS) materials is Nb₃Sn, an intermetallic compound having the so-called A-15 crystal structure. Both intermetallic and ceramic high temperature superconductor (HTS) superconductors perform better when the superconductive material is divided among a number of filaments embedded in a metallic matrix. LTS and HTS materials have been prepared as multifilamentary conductors. Multifilamentary wires are particularly useful at low temperature or to reduce ac losses. At higher temperature, i.e., ≧20° K., a monofilament wire can sometimes be used.

A typical process for the manufacture of a multifilamentary Nb₃Sn conductor begins with the drilling of a plurality of holes in a Cu/Sn bronze billet for the insertion of Nb rods. This billet is then extruded to a rod, drawn down to fine wire, and then heated to form the superconductor. A higher filament count is achieved by cutting the rod prior to drawing into a large number of equal lengths at some intermediate size, inserting these into an extrusion can, extruding this assembly and drawing the resultant billet into a wire, which is then heated to form the superconductor. The rod may be drawn through a hex-shaped die prior to cutting, which provides a space filling shape for subsequent assembly.

Mechanical alloying of constituent metals of a superconducting material also is known. Mechanical alloying has long been known and was originally developed for the manufacture of high strength structural alloys. Mechanical alloying has been used for the production of low temperature superconducting Nb₃Sn and Nb₃Al powders. See Larson et al., Manufacture of Superconducting Materials, Proc. Intl. Conf. November 1976, Ed. R. W. Meyerhoff, p. 155 (1976).

In the field of HTS, mechanical alloying has been used to make so-called metallic precursor filaments in a metallic matrix, which can be shaped in the metallic state and then transformed into the HTS ceramic oxide wire after completion of the extrusion and wire drawing. For example, suitable metal powders are milled into a fine metallic powder that is used to fill silver tubes that are then processed by extrusion or drawing into filaments. These are then bundled in a silver tube, and extruded again to make a multi-filamentary wire, if desired. The HTS phase is formed by oxidizing the metallic precursor filaments. Transmission electron microscopy of the metallic precursor powders has shown that these are not layered but amorphous, with no discernable or very fine grained multiphase crystalline structure. The elements are often well mixed on an atomic scale. See, Otto et al., IEEE Trans. Appl. Supercond. 3(1):915 (1993); and Yurek et al. Met. Trans., 18A:1813 (1987).

Much is known about the superconducting properties, but less is known about related processing capabilities, for the newly identified superconductor MgB₂. Methods of forming magnesium boride precursor powders, of obtaining long lengths with high critical currents of magnesium boride superconductor wires or tapes are desired.

### SUMMARY OF THE INVENTION

The present invention provides novel processes for the manufacture of MgB₂ wires. MgB₂ provides an interesting alternative material to HTS oxide superconductor for wire and cable manufacture. MgB₂ appears to be strongly linked with good prospects for being made as a round filament wire that can be twisted and cabled, so that the development of an ac wire functional at temperatures below and up to about 30K is feasible. The processes of the invention for fabricating MgB₂ superconductor into long lengths provide attractive routes to mono- and multi-filament wires and tapes. The process of the invention also provides access to a composite material having an interconnected magnesium boride network that provides an adequate fraction of connectivity throughout the composition to achieve practical critical current levels. The superconducting wire may be used, for example, in motor windings, generators, cables, MRI magnets and other magnet applications. Throughout the specification, “wire” and “tape” are used interchangeably, unless otherwise noted.

In one aspect of the invention, a superconducting article includes one or more elongated metal matrix regions containing one or more embedded elongated superconducting Mg—B regions running the full length of the article, wherein the superconducting Mg—B regions have a density greater than 95% of the theoretical density, and a transition temperature in zero field of 30 K.

In one or more embodiments of the present invention, the Mg—B superconductor comprises approximately 53 weight % Mg and 47 weight % B, the Mg—B superconductor comprises MgB₂.

The article can be a monofilament or multifilament. It can be a round wire or an aspected tape. In one or more embodiments, the cross-sectional dimension of the article is in the range of 0.1 mm² to 5 mm² and/or 40% to 80% of the cross-section is comprised of a non-superconducting metal matrix.

In one or more embodiments, metal matrix is comprised of copper or a copper alloy, or the metal matrix is selected from the group consisting of stainless steel, oxide dispersion strengthened copper and nickel alloys.

In one or more embodiments, a metal matrix is comprised of copper or a copper alloy, and a second metal layer between the Mg—B regions and the copper regions. The second metal layer is a barrier layer or a high resistivity layer. In one or more embodiments, the barrier layer is selected from the group consisting of tantalum, niobium, nickel, nickel alloys, iron, tungsten, molybdenum and combinations thereof. In one or more embodiments, the resistivity layer is selected from the group consisting of cobalt, manganese, NiTi, and NiZr.

In one or more embodiments, the superconducting regions further comprise flux pinning sites. The flux pinning sites are selected from the group consisting of particles of metal diborides, rare earth oxides, boron oxide, MgO, and boron.

In one or more embodiments, the superconducting article of claim 1, further includes a metal laminate on the outer surface of the article. The metal laminate is selected from the group consisting of copper, copper alloys, stainless steel, aluminum, aluminum alloys, and nickel alloys.

In another aspect of the present invention, a method of making a high density Mg—B superconducting article includes the steps of providing a packed powder sheath, said powder comprising a source of magnesium and boron, subjecting the packed powder sheath to a symmetric deformation, said deformation selected to elongate the packed powder sheath to form a wire while retaining the free flow of particles within the powder core, subjecting the wire to high reduction rolling, said high reduction rolling selected to reduce the wire thickness by 40 to 95%, and heating the rolled article to improve the superconducting properties of the article.

In one or more embodiments, the powder of the packed powder sheath includes a mechanically alloyed Mg+B powder, or a mixture of boron and magnesium, or MgB₂. The particle size of the powder is in the range of 10 nm to 1 micron.

In one or more embodiments, the Mg—B superconductor further comprises flux pinning sites.

In one or more embodiments, the matrix is comprised of copper or a copper alloy.

In one or more embodiments, the packing density of the packed powder sheath is in the range of 35 to 80%.

In one or more embodiments, the symmetric elongating deformation is selected from the group consisting or wire drawing, extrusion and rod rolling. Wire drawing is conducted using a die having a total die angle greater than or equal to 14°, or a die having a total die angle in the range of 14° to 25°.

In one or more embodiments the high reduction rolling reduces thickness in the range of 50 to 75%, and/ the high reduction rolling is carried out using large diameter rolls that have a large contact area with the wire. The large diameter rolls have a diameter greater than 2 inches, or 4 inches.

In one or more embodiments, a low reduction rolling is carried out before the large reduction rolling and/or the low reduction rolling reduces the thickness of the wire by less than 20% per pass and/or the low reduction rolling alters the shape of the wire to provide a geometry that has a larger contact area with the roll in the subsequent high reduction rolling operation.

In one or more embodiments, the wire has a geometry is round, oval, square, rectangular or tape-like prior to high reduction rolling.

In one or more embodiments, heating is carried out to convert a precursor of the Mg—B superconductor into the Mg—B superconductor and/or to sinter the Mg—B superconductor.

As used herein, “about” refers to ±10% of the recited value.

### BRIEF DESCRIPTION OF THE DRAWINGS

The invention is described with reference to the drawings, which are presented for the purpose of illustration only and are not limiting of the invention, and in which:

FIG. 1 A-C is an illustration of a model for mechanical alloying of ductile metals;

FIG. 2 is a flow diagram for the production of multifilamentary MgB₂ wire, in which the final wire is optionally heat treated to enhance the superconducting properties, such as critical current density;

FIG. 3 is a schematic illustration of a CVD process used in the manufacture of MgB₂ fine powders;

FIG. 4 is a temperature vs. Mg—B phase diagram indicating the presence of solid, liquid and vapor phases;

FIG. 5 is a photograph of a cross section of wire made up of an Mg- and B-containing precursor powder in a copper sheath, prepared according to at least one embodiment of the invention;

FIG. 6 shows 12 x-ray diffraction traces for the cores of magnesium-boron material reacted at different temperatures and durations in an atmosphere of 5% H₂ and 95% argon; the upper trace shows the pattern for the precursor magnesium-boron material and the bottom trace shows the pattern for a conventional ceramic pellet sample reacted at 900° C.;

FIG. 7 shows a plot of critical current density, J_{c}, as a function of applied magnetic field for an alloyed sample reacted for two hours at 600° C.; and

FIG. 8 illustrates the high reduction rolling process used in the manufacture of superconducting wire according to one or more embodiments of the present invention.

### DETAILED DESCRIPTION OF THE INVENTION

MgB₂ has some unique processing requirements if it is to be successfully processed into superconducting wire. The magnesium component of the material is water and oxygen sensitive. See, Larbalestier et al., Preprint. In addition, boron reacts readily with nitrogen in the atmosphere to form boron nitride. Boron also is much more brittle than any of the component elements of traditional intermetallic superconductors. The brittleness of boron as a starting material and the nitride reaction products also needs to be addressed if the material is to be successfully processed into wires and cables.

In one or more embodiments of the invention, a fine particle size, homogeneously dispersed Mg- and B-containing powder is provided for use in the manufacture of MgB₂ superconducting wires and tapes. It has been discovered that commercially available materials, such as MgB₂ available from Alfa-Aesar, is not optimal for high performance wire fabrication process contemplated herein. Analysis of these powders under high magnification shows that the powder is non-homogenous. Furthermore, analysis by scanning electron back scattering detection establishes that these materials are boron-rich or even contain unreacted boron.

In one aspect of the invention, the constituent elements of the MgB₂ superconductor, magnesium and boron, are mechanically alloyed under controlled conditions to provide an intimately mixed reactive power for the preparation of the superconducting product. Mechanical alloying includes the mixing and milling of source powders often without chemical reaction between constituents. Mechanical alloying is carried out under conditions that substantially avoid the formation of secondary phases and contaminants that are deleterious to the superconducting properties of the product. During milling, the source powders are co-deformed and become intimately mixed and bonded, often forming true alloys with relatively homogeneous distribution of the chemical constitutents even at the atomic scale. The method not only produces powders but mixes elements on a scale that is normally only possible with miscible liquids, or when using diffusion-based homogenization at very high temperatures. The method also allows the production of metastable powder mixtures. The reactive powder reacts at lower temperatures and in shorter reaction times to form the superconductor than conventional powders.

“Mechanical alloy” refers to constituent elements of a powder that are finely dispersed and that have a dimension on the nano- to submicron-scale. A mechanical alloy is a homogeneous dispersion, demonstrates high reactivity to form the product and a high tendency to densify and sinter upon heating. The ability to sinter provides connectivity with the powder and increases critical current and critical current density.

In one or more embodiments the elements are combined in amounts approximating their stoichiometry in MgB₂ that is about 53 wt % Mg and about 47 wt % B. Variation about the stoichiometric proportions is contemplated. The starting metal powders can be fine or coarse powders, but also may be metal flakes, chips, turnings, or chopped wire. The source can be elemental, e.g. Mg and B metal, or it can be an alloy, for example, Cu—Mg alloy, or a compound such as a boride, for example MgB₄ or MgB₇.

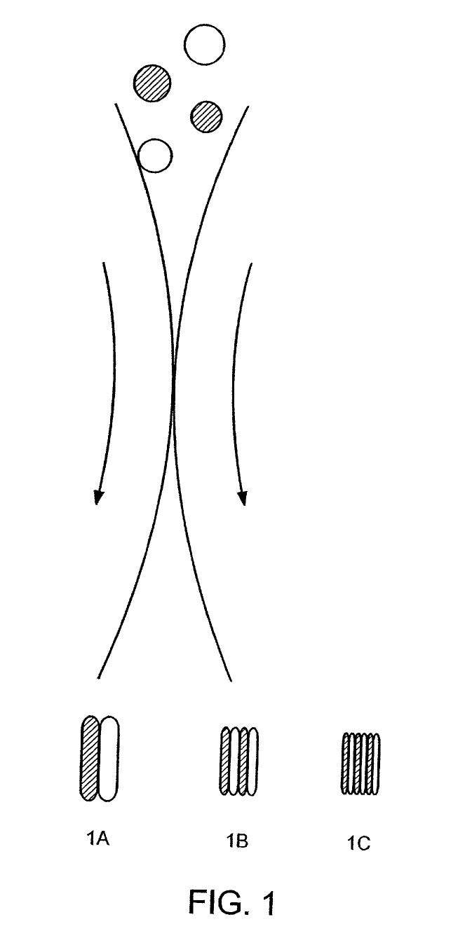

FIG. 1 shows a model for mechanical alloying of ductile metals that can be used in one or more embodiments of the invention. In the initial stage particles are bonded together as shown in FIG. 1A. With repeated feed-through the particles will look like those shown in FIG. 1B and later, as in FIG. 1C. With progressive milling the powder will break up and form a fine, multi-layered powder.

The actual deformation path during the process can differ substantially, depending on the powders that are used, whether these are ductile or brittle, or whether they work-harden rapidly, the starting size and so on. The powder mixture is passed through a rolling mill or milled in a ball or rod mill. This powder may be processed into wire using a powder-in-tube (PIT) or powder in wire (PIW) method, as described herein below.

In one or more embodiments of the present invention, precursor materials to the magnesium boride superconductor are prepared by mechanically alloying constituents elements and/or intermetallics, e.g., Mg+B, or Mg+MgB₄ or Mg+B+MgB₄ or Mg+MgB₇ or these combinations with added components, e.g., transition metal elements. For example, lithium, silver, palladium, copper or aluminum may be added to increase the hardness of the magnesium, which is otherwise very malleable and soft. In some embodiments, a magnesium alloy may be used in place of magnesium. Suitable magnesium alloys include, for example, Mg—Cu alloy, Mg—Li alloy or alloys with other elements that do not influence superconductivity, but which affect the alloying properties of magnesium.

In one or more embodiments, alloying is carried out at lower than ambient temperatures, and preferably it is carried out at temperatures significantly lower than ambient temperatures so as to prevent sticking, large alloy particles and deleterious chemical reactions. In one embodiment, mechanical alloying is accomplished at less than −20° C., and more preferably at less than −100° C. in order to obtain the desired fine particle product. The loading and processing of the constituent powders are done under inert gas conditions to prevent oxidation of the constituent powders, or reaction with nitrogen (to form BN) or reaction with water vapor (to form MgO or Mg(OH)₂) and uptake of contaminants such as carbon (from CO₂) and sulfur. Milling at lower than ambient temperatures also reduces reaction with trace amounts of oxygen, carbon, H₂O, sulfur, and nitrogen.

In one or more embodiments, magnesium- and boron-containing powders are milled in a ball mill, a high energy ball mill or rod mill. Mechanical alloying may be accomplished by Spex, ball or rod milling. With Spex milling (a high energy form of ball milling), the total milling time is typically less than 1 hour, while with ball or rod milling it is typically less than 6 hours. However the milling procedure may consist of periodic stoppage of the mill, followed by re-cooling to dissipate the heat of work and friction, or even discharging the mill, crushing the constituents (via for example a hammer mill) and re-loading the charge and continuing with milling. This cycle may be repeated for example up to 6 times. Milling may be accomplished with the charge in liquid slurry, or more preferably dry. The milling media can be steel, copper, carbide (for example, tungsten carbide) or ceramic (for example, zirconia) in the form of for example balls, rods or pellets.

In one or more embodiments, additional elements such as sodium, lithium, or calcium can be included in the precursor mixture in order to enhance milling and the superconductor properties. In one or more embodiments, these elements are added as metal hydrides to maintain reducing conditions in addition to any other advantageous effects the elements may have on milling and/or superconducting properties. Additional elements to dope the superconductor for enhanced properties can be similarly included. The methods disclosed herein are well-suited for the preparation of doped magnesium boride, and such variations are contemplated as within the scope of the invention. By way of example only, mechanical alloying of alkali metals and alkaline earth metals as dopants may be readily accomplished using the methods of the invention.

In one or more embodiments, the average particle size is in the range of about 5-100 nm, and in some embodiments is in the range of about 5-30 nm. The particle size range or distribution can be from about 0.005 μm to 100 μm (microns), and preferably in the range of 0.005 μm to 1 μm. The precursors may consist of the elements, Mg and B, in appropriate proportions to make the desired superconductor, e.g. in a ratio of about 53% Mg to 47% B by weight. Alloying conditions and alloying additives are selected to avoid the harder elemental boron from becoming embedded in a soft magnesium matrix. In addition, use of small particle size boron can result in work hardening as the particles tend to act as pinning centers for dislocations. The work-hardened composite is more readily broken up into fine power. The primary precursors may also consist of other mixtures to achieve the final MgB₂ composition, such as Mg+MgB₄ or Mg+B+MgB₄. In one or more embodiments of the invention, the Mg is prealloyed or reacted with Cu to form an intermetallic compound. This is then milled with the boron or MgB₄ to form a copper-containing precursor material.

Other methods of preparing fine powder Mg—B material are contemplated for use in the wire preparation methods of the present invention. In one or more embodiments of the invention, superconducting MgB₂ powder is formed in a vapor phase reaction of the constituent elements. For example, the formation of MgB₂ includes the direct reaction of the elements, e.g., Mg vapor may be reacted with B at 800°-1000° C. to form MgB₂. This generally results in powder with a particle size reflecting the particle size of the starting B powder, e.g., larger than the preferred particle size. Milling powder to fine size can enhance homogeneity and reduce particle size.

The precursor powder can include finely dispersed boron particles in a reactive secondary, e.g., magnesium-containing, mixture. In one or more embodiments, the boron particles are less than 10 microns (μm), or less than 5 microns (μm), or less than 2 microns (μm) or even 1 micron (μm), for obtaining uniform properties in reasonable processing times. The smaller particle size of the elemental boron promotes a more complete and uniform reaction of the boron with magnesium (or other cation). The fine boron particles are reacted in a solid state reaction with magnesium-containing particles. The boron particles are also reacted with a magnesium source as a solution or vapor. An additional feature of fine particle size starting materials is that the reaction temperatures may be lowered. By using a more reactive phase, i.e., fine particles and solution or vapor phase reactants, the reaction temperature may be as low as about 500° C., although higher temperatures are also contemplated as within the scope of the invention.

In one or more embodiments of the invention and in order to overcome the low vapor pressure of boron at accessible temperatures, boron is produced directly in the presence of magnesium vapors at temperatures where the reaction of magnesium and boron occurs rapidly, or even instantaneously. One approach to producing boron is the pyrolysis of BI₃ on a Ta surface at 800°-1000° C. The pyrolysis is carried out in the presence of Mg vapor, and the formation of MgB₂ occurs almost simultaneously with the formation of the boron, resulting in an ultra fine particle size for the MgB₂. The precise particle size should be readily controllable by the concentration of the BI₃ and Mg vapors in the reaction chamber and also the temperature of the reaction. Other volatile boron compounds such as the boranes (i.e., B₂H₆) could also be used with this approach. In another variation, the tantalum (Ta) surface may be a fine filament that is continuously pulled through the reaction zone. In this configuration, the MgB₂ in the reaction can be deposited as a film directly on the Ta filament. Other metals or metal alloys having similar characteristics could be used. In another approach, magnesium and boron halides or other soluble reagents may be taken up into solution and nebulized into fine droplets prior to heating.

The additives and other processing variations described herein for mechanically alloyed powders may also be used in the processing of fine particle size boron precursor powders and vapor phase reacted precursor powders.

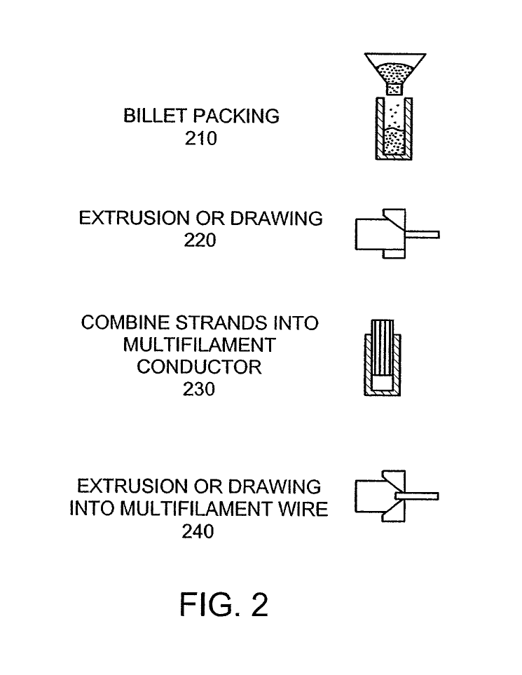

A typical process for the production of MgB₂ wire, which permits the formation of long lengths of wire from an Mg—B powder according to at least one embodiment of the invention, is shown in FIG. 2. In order to obtain a wire having a dense, homogeneous powder core, the precursor powder is of homogeneous composition, fine particle size and is free flowing. Such a powder is obtained using one or more of the powder fabrication methods described herein. Alternatively, any source of free flowing powder having compositional homogeneity and fine particle size can be used according to one or more embodiments of the present invention. For example, a commercial source of MgBr₂ can be milled to reduce particle size and improve homogeneity.

According to one or more embodiments of the invention, a mono- or multifilament composite wire or tape is prepared by packing any of the herein-described precursor powders or prereacted powders into metal cans, as indicated in step 210 of FIG. 2. Prereaction can be carried out at elevated temperatures to form the superconducting form of magnesium diboride prior to billet packing, if desired. The cans are inert (non-reactive at processing conditions) to the MgB₂ superconductor and can consist of copper, or tantalum-lined copper, or niobium-lined copper, or iron-lined copper.

The packed billets are evacuated and sealed, or back-filled with an inert gas. Then, the cans are deformed into monofilament rods or wires, as indicated in step 220. The preferred deformation method may be drawing, extrusion or rod rolling at ambient or slightly elevated temperatures. For high-speed deformation, it is possible to chill the workpiece below ambient temperature in order to counteract the work-induced heating effects. This process is commonly referred to as a “powder-in-tube,” or PIT process.

Wires or tapes that contain powder cores with the purpose of making a superconducting wire or tape typically benefit when these powder cores are as dense as possible at the end of the aforementioned deformation process. High powder density after wire formation favors dense powder cores in the final product, i.e., after reaction to form the superconductor or sintering of the superconductor grains. When brittle precursor powders (such as intermetallics, oxides, or nitrides) are used, densification of the core takes place at the end of the deformation process. Having dense cores at the start or middle of the deformation process makes further deformation processing more difficult, and the higher deformation forces can cause wire breakage or powder core fractures. Similarly, sintering of the particles should be avoided until the final stages of the operation.

In one or more embodiments of the present invention, the deformation process used to form the wire leaves the powder core(s) relatively loose and free-flowing. For example, the billet is packed to be reasonably dense, but not too high. A packing density of 50-70% can be used according to one or more embodiments of the invention. Lower packing densities are contemplated, however, the actual fill factor (or percentage of superconductor) is low as well, and the final superconductor will carry proportionally less current.

The manner of deformation can also effect powder densification. In one or more embodiments, the billet is deformed in a manner that leaves the powder core(s) free-flowing for subsequent deformation steps. Wire drawing can be used for this purpose. In one or more embodiments, the die angle is selected to promote elongation of the wire (as compared to compression) and to preserve the free flow of particles within the powder core. In one or more embodiments, a high angle die is used. In one or more embodiments, the total die angle is greater than or equal to 14°, or is in the range of 14-25°. A 16-18° total die angle works very well for mono-core wires with MgB₂ powder. The particles remain free-flowing along the drawing direction over wide deformation range, despite the increased work hardening of the sheath material. On the other hand, shallow die angles (8° total die angle for example) tend to densify the powder cores as particles can not roll easily over one another. The particles tend to remain where they are rather than being pushed in the elongation direction; thus, the powder core will compact and become harder to deform, and will finally fracture.

In those embodiments where a multifilament wire is desired, the space-filling monofilament rods produced in step 220 may be cut, cleaned, bundled and packed into another billet, tube or can (step 230), followed by deformation processing into fine multifilament wire (step 240). The rebundling and deformation steps may be repeated several times in order to attain the desired filament dimensions and filament count. Typical filaments in a multifilament wire are in the range of about 1 to 20 micrometer in diameter.

The resultant wire can be rolled to form a tape, and the wire or tape then is heated to form the superconducting phase and/or to sinter the superconducting powder core. Compressive stress can be introduced into the wire, which has been observed to improve critical current. A variety of techniques can be used to impart compressive stress, such as hydrostatic extrusion and wire drawing, hot forming and high reduction rolling. While not being bound by any specific mode of operation, it is believed that the observed improvements in critical current are due to increased powder density achieved by this process and/or to increase texture.

In one or more embodiments, a rolling draft is used to form a superconducting tape. As for the wire formation step, the manner of rolling can affect the wire properties, particularly powder density and homogeneity. Large diameter rolls resemble drawing dies with low die angles. These rolls tend to densify cores, and further rolling becomes more difficult. In the extreme, rolling a wire with a large diameter roll resembles pressing the wire with a two-sided press in which particle movement is very limited.

For example, rolling a mono-core wire (Ni sheath with MgB₂ powder) with wide, e.g., 4 inch, diameter rolls at 20% per pass leads to rapidly densifying cores, and after a few passes the wire shows defects such as edge cracking, splitting of top and bottom, and cracks in the cores. In contrast, rolling the same type of wire at 10% deformation per pass using small, e.g., ½-1 inch, diameter rolls does not densify the core, and can be practiced until the moment when core densification is desired. At this stage densification is achieved, for example, by rolling at 20% deformation per pass using 4″diameter work rolls. Dense cores are obtained; however, core homogeneity suffers because deformation is not uniform along the length of the wire, and cores with a varying core cross section (so-called sausaging) are often the result. Such varying core cross sections are detrimental for the superconducting properties.

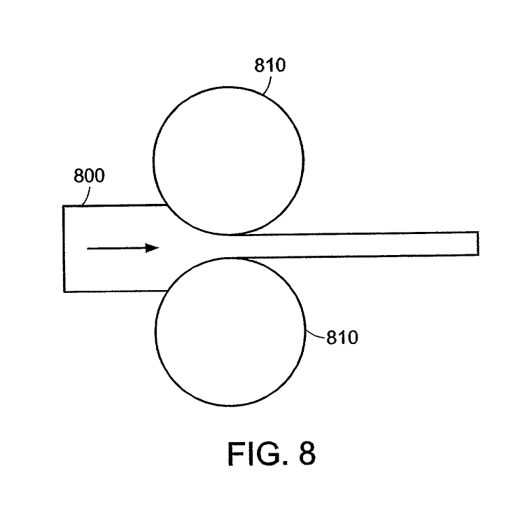

In one or more embodiments, a high reduction rolling draft is used. A high reduction rolling draft reduces the wire thickness by 40 to 95% in a single step. The principle of high reduction rolling is shown FIG. 8. It shows a wire 800 (which can be round, oval, rectangular or square) being rolled using working rolls 810 at a large deformation strain to a thin tape, all in one pass. Typically, these strains are in the range of 40-95%, more typically in the 50-85% or 50-75% (strains correlate to the percent reduction in thickness). Powder core densities of greater than 80%, or greater than 95%, or theoretical density can be achieved.

Single pass rolling (SPR), as it is called due to the fact that the desired degree of densification and thickness reduction is attained in a single pass of the material through the rolls, is both cheaper and more effective in producing tapes with dense and even powder cores. The powder cross sections vary very little along the length of the tape. SPR also tends to orient plate-like powder particles with the surface parallel to the tape surface. As MgB₂ has a plate-like hexagonal structure, an increased degree of texturing is expected to enhance the superconducting properties.

In one or more embodiments, a small reduction pass can be carried out prior to SPR. The small reduction is in the range of less than 20%, or less than 10%. The small reduction roll can alter the shape of the wire to increase the contact area of the wire with the large diameter roll used in a subsequent high reduction, densifying rolling step. Contact area is defined as the area of the wire that is in contact with the roll from the point of initial contact to the narrowest point of contact at the nip. The greater the contact area, the greater is the uniform compressive force.

SPR is a very homogeneous deformation process, and powder core (or filaments) and metal matrix deform in an even manner. The resulting microstructure shows filaments with an even, unchanging cross section. This enhances the critical current of the final superconducting tape and the sharpness of the superconducting-to-normal transition. For this the index value n is a good indicator. In the superconducting state, the voltage V (V=Iⁿ) is zero for any current I until the critical current I_{c} is reached and a voltage V becomes evident. Superconductors with homogeneous filaments have higher n-values than superconductors with filaments in which the cross section varies.

SPR is equally useful for multifilamentary and mono-core tapes. SPR can be used for many different powders, provided they do not stick or react prematurely. The mono-filamentary MgB₂ tape is cheaper to produce than a multifilamentary tape as a bundling step can be omitted. At low temperatures such as liquid helium (4.2K) the stability of such a mono-filament conductor would be very low, and the conductor would have to be made as a multifilamentary wire to make it functional at 4K and magnetic field. However, at temperatures exceeding 20K this stability is much less of a problem, and mono-core wires or tapes offer interesting commercial possibilities.

The wire fabrication process can be modified as needed to take into account the use of different starting precursor materials. Typical precursor materials include a mechanically alloyed Mg+B powder and a fully reacted MgB₂ powder (and any additives to the powders as is discussed herein).

Mechanically alloyed Mg+B contains a mixture of ductile magnesium metal and more brittle boron. Deformation on such a material takes into account the very different responses the two components of the powder have to deformation forces. Mechanically alloyed Mg+B powder is expected to deform well as long as the temperature is low enough to prevent reaction, e.g., Mg+2B=>MgB₂. To avoid sticking or sintering of the powder during those steps of the process where a free flowing powder is desired, i.e., prior to SPR densification, the temperature is maintained below the reaction temperatures of the mechanically alloyed material to form MgB₂.

The fully reacted MgB₂ can be a commercially available powder, such as that available from Alfa Aesar, although it is contemplated that milling of the material to reduce particle size and improve homogeneity may be carried out. The fully reacted MgB₂ powder typically provides a uniform response to deformation, unlike the mechanically alloyed powders. However, the fine, relatively low aspect particles (as compared to the high aspect particles typically associated with high temperature oxide superconductors) are unlikely to further fracture during deformation. The fully reacted MgB₂ powder can be any powder made by the powder preparation methods disclosed herein. MgB₂ powder typically is provided as a free flowing powder. To avoid sticking or sintering of the powder during those steps of the process where a free flowing powder is desired, i.e., prior to SPR densification, the temperature is maintained below the sintering temperatures of MgB₂.

In one or more embodiments, the rolled tape is laminated to impart strength to the final article and to provide stability under cryogenic conditions. The laminate is typically a metal strip that is applied to the outer surface of the tape under pressure. The metal strip can include copper or high strength copper alloys, such a beryllium-copper alloy.

Alternatively, a composite wire is obtained using a technique known as “powder-in-wire,” or PIW. In this method, the powder is continuously laid in a trough or furrow that has been introduced into a long length of metal. The trough may be lined with an inert or diffusion barrier material, such as niobium, tantalum or iron. The metal length itself is moved through the process in a reel-to-reel manner. After introduction of the powder into the trough, it is sealed to form a wire. The resulting monofilament may be processed to densify the powder, for example, by drawing, extruding or rolling. The wire may be heat treated or sintered to provide grain connectivity. This monofilament wire may be processed further as described below.

For ac applications, copper can be replaced by a ductile alloy, such as a copper alloy with a high resistivity that reduces ac losses in the superconducting wire, for example, a Cu—Al alloy or Cu—Al—Ni alloy. Higher resistance layers between the filaments may be introduced by use of a composite monofilament billet with Cu—Ni, or a similar alloy jacketing the outside of the billet. Magnetic scattering is favorable for inducing resistance in the regions between the superconducting filaments, for example by use of a high resistance layer including Mn, Fe, Co or Ni. In a monofilament, a strong sheath material can be selected, such as stainless steel, oxide dispersion strengthened copper, or nickel alloy, making use of the can liners previously described. Monofilaments are typically not used in ac applications so that the requirement of high resistivity is not found.

For ac applications, the wire is twisted about its axis to tight pitches in the 0.2-20 cm range. The round precursor wire may be converted into the superconductor in its present form, or it may be shaped, i.e. rolled, into tape or other form prior to processing. Monofilament forms (wire or tape) of diameters in the 0.1 to 3 mm range and tapes of about 0.1-2 mm thick and 1-20 mm in width can be formed, with cross-sectional areas of 0.1 mm² to about 5 mm².

Although PIT and PIW methods have been described with specific reference to mechanically alloyed powders, it also is contemplated that these methods may be practiced using the fine particle powder precursors described herein.

The precursor material inside the composite filaments can be reacted by pulling the wire through the hot zone of a furnace and back out again in a continuous reel to reel approach. However, the reaction can also be activated and sustained by passing an electric current through the whole wire all at once, or through a select segment of the wire, with electrical contacts moving along the wire in a continuous process. The reaction furnace can be flooded with an inert or reducing gas (for example, hydrogen or nitrogen or argon or carbon-monoxide gas, or mixtures) or vacuum. In yet another approach the wire is heat-treated as a coil under pressure by hot isostatic pressing (HIPing). In yet another approach to densifying the precursor as it converts to the superconductor, the composite is hot deformed at the reaction temperature, with direct heating derived from the hot tooling. Reaction temperatures may be in the 500° C. to 1200° C. range, but preferably in the 500-1000° C. or 650-800° C. in order to minimize secondary reactions. With appropriate conditions, the heat generated by the exothermic diboride forming reaction is employed to accelerate the reaction and reduce processing time. Short reaction times make it possible to carry out the process in a continuous manner, with the wire precursor passing continuously through a furnace. The wire can be processed reel to reel or in batches. The batch process is carried out by forming and heating a coil of the wire to obtain the superconducting phase.

In one or more embodiments of the invention, flux pinning particles are introduced, e.g. by milling, into the precursor during precursor fabrication. These include diborides, e.g. TiB₂ or ZrB₂, that are more stable than the superconducting diboride. The particle size of these secondary particles is less than 0.1 micrometers, and can be, for example, MgO, boron oxide, rare earth oxides or excess boron.

Flux pinning centers can also be introduced by chemical means, involving formation of second phase precipitates within the superconducting material or at its grain boundaries. The precursor to the superconductor is then doped with an appropriate element such as carbon, a transition metal or an alkali metal, which is introduced either elementally, or as part of another material (carbon as a carbide, metals as borides or carbides). The dopant is dissolved into the superconductor or its precursors at high temperatures, but is subsequently precipitated to form secondary phases at lower temperatures (for example, in the 300° C. to 750° C. temperature range), different oxygen potentials (higher than the reducing conditions within the composite, for example, at 10⁻⁹ to 1 atmosphere oxygen equivalent activity) or different mechanical pressures those employed to form the superconductor.

The final microstructures with these artificial pinning centers (whether introduced directly during precursor fabrication or subsequently by forming it chemically after formation of the precursor) include dispersed particles, or more preferably, elongated rods or sheets of the secondary phase. The use of very fine carbon or ceramic fibers (oxides of aluminum, zirconium, yttrium, ytterbium, lanthanum, thorium or calcium, glass fibers, silicon, tungsten or boron carbide fibers, or fibers of various borides including non-superconducting magnesium boride fibers) is contemplated according to one or more embodiments of the invention. If flux pinning centers are formed in situ, elongated or fibrous secondary phases can be formed within grains or more preferably, at the triple junction boundaries of the fine superconducting grains where three or more grains intersect. This latter mechanism requires very fine grained superconductor, which may be formed reactively at low temperatures (500° C. -800° C.), or by milling together very fine grained MgB₂ (<1 micrometer in size) with some (5 to 30 weight percent) additional Mg and B (in one of the combinations described previously) to allow reactive sintering of the grains at low temperature. For this case, the fully reacted and sintered superconductor would be formed with local temperatures (at the reaction site) in the 500° C. -800° C. temperature range. If copper metal is added to or alloyed with the precursor as described above, then it also precipitates at low reaction temperatures from the precursor as very fine particles, rods or sheets as the MgB₂ forms, thereby providing the required flux pinning. Metals other than copper can also be used in this manner to form flux pinning centers.

In another aspect of the invention, MgB₂ films are provided.

In one or more embodiments, a boron layer is deposited on a non-reactive surface, such as for example tantalum, niobium, copper, iron nickel or aluminum, and the coated substrate is post-treated with magnesium vapor to form magnesium boride. Other metals or metal alloys having similar characteristics could be used as substrates. The substrate can be textured or a single crystal. A boron layer can be deposited using various known deposition methods, such a physical vapor deposition, plasma sputtering or other ablative technique, or plasma spray deposition. Other methods are immediately apparent to those of ordinary skill in the art and are contemplated within the scope of the invention. In one or more embodiments, a layer of boron of a desired thickness, e.g., 10 microns or less, is deposited, and the boron-containing substrate is then introduced into an environment, e.g., a reaction chamber, containing magnesium vapors. Magnesium has a relatively high vapor pressure and will vaporize at temperatures above its melting point. The magnesium vapor reacts with the boron layer, for example, at temperatures of about 950° C. The reaction may be carried out in a water-cooled quartz reaction chamber or a tantalum-lined reaction chamber. Sequential layers can be deposited and reacted to create structures having thicknesses of greater than 10 microns (μm).

In another aspect of the invention, an MgB₂ superconductor is formed using chemical vapor deposition (CVD).

In one or more embodiments, MgB₂-coated fibers or foils are prepared using magnesium and boron halides, which decompose and react on the designated surface. For example, MgCl₂ has a vapor pressure of 0.2-1.4 Torr between 800 and 1000° C., while BCl₃ has a vapor pressure of around 4 Torr at these temperatures. MgI₂ has a vapor pressure of 0.6-1.9 Torr at 800-1000° C., while BI₃ has a vapor pressure of around 5 Torr at 800 °-1000° C. These halides can be used as reactants in the presence of hydrogen, where H₂ will reduce the halides to intermetallic MgB₂. The halides are reduced and reacted according to eq (1):

MgCl₂+2BCl₃+4H₂→MgB₂+8HCL eq (1)

The reduction takes place at the surface of the heated substrate, which can be an inert fiber such as Ta- or Nb-coated carbon or stainless or Ni alloy steel, fine Cu, W, Ta or Nb filaments. Alternatively, the substrate can be a heated foil such as Cu, Cu alloy such as Cu-4% Al, or a Nb, Ta, or stainless steel or Ni alloy foil.

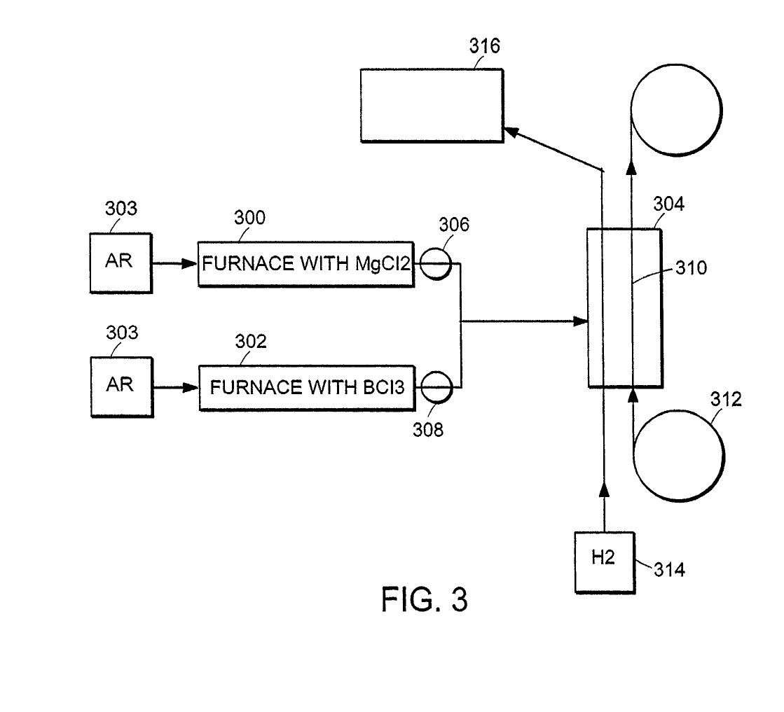

A method of MgB₂ film formation is shown in FIG. 3. The halides are evaporated in individual furnaces 300, 302 and carried by a neutral gas 303 such as Ar into a reaction chamber 304. The gas flow controllers 306, 308 regulate the mass flow for each of the constituent halides. In a reaction chamber 309, a heated substrate 310 passes by using a reel-to-reel system 312, while a reducing gas 314 such as H₂ or Ar—H₂ gas mixture is passed over the heated substrate surface 310. The HCl generated as in eq. (1) is carried off in the hydrogen gas flow, and is passed through a neutralizing bath 316.

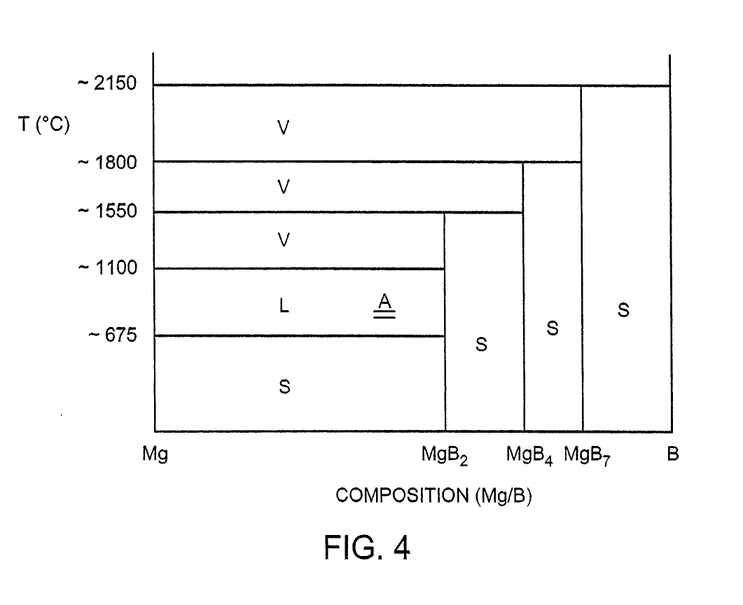

In yet another aspect of the invention, long lengths of superconductive material may be prepared as fibers. Fibers may be pulled directly from a melt of the appropriate composition. An Mg—B vs. temperature phase diagram is shown in FIG. 4. The composition of the melt is selected to obtain a congruent boron/magnesium melt. FIG. 4 indicates the existence of a magnesium-rich liquid phase, such as region A. A Mg—B containing fiber may be directly pulled from the melt having a composition within region A at temperatures of less than 1100° C. The melt can optionally include a flux to modify the melt properties of the melt.

In many of the above embodiments, the magnesium boride superconductor is in contact with non-superconducting surfaces, whether in a composite wire or a thin film, and other architectures. It is desirable that the surface in contact with the superconductor is chemically compatible, that is, that the surface does not react with or otherwise poison or contaminate the superconductor. To this end, materials used in processing of the magnesium boride superconductors should be substantially inert to the superconductor under processing conditions. Where not possible, a diffusion barrier may be employed. Multiple layers may be used as a diffusion barrier, including layers that are a mixture of borides, for example, a mixture of magnesium boride with other inert materials. Exemplary materials include tantalum or niobium. Other metals or metal alloys having similar characteristics could be used.

The invention is illustrated in the following example, which is not intended to be limiting of the invention.

### EXAMPLE 1

This example describes the preparation of mono and multifilamentary MgB₂ wire from mechanically alloyed powders.

A mechanically alloyed Mg—B power was obtained by Spex milling. An Mg—B powder was prepared from Mg powder (average particle size of ˜40 micron with pieces spanning a range from <1 micron to ˜100 microns) and boron powder (particle size of one micron or less). The powder was milled under cryogenic conditions in a Spex mill (10 minutes ×3 with 90 degree rotation between runs) under inert gas in the vials (Argon or Helium). Specifically, the charged mill vials were chilled by immersion in liquid nitrogen, followed by 10 minutes of spex milling with the spex mill in a liquid nitrogen-refrigerated enclosure. During this period the vial heated to a final temperature of about −20° C. from the heat of work and friction. After each 10 minute run, the vial was transferred to an inert atmosphere glove box and the contents examined for sticking and extent of mechanical alloying. The procedure was repeated three times—but in general may be repeated any number of times from one through about 10. In a refined approach after the first run series, the vials were merely re-immersed in liquid nitrogen after the 10 minute milling run, followed by further spex milling with the vial rotated 90 degrees to minimize alloy build-up on the vial walls. Experiments were also completed that showed the milling time could be varied from about 5 minutes to an hour without deleterious effects. Ball milling equivalent times were also calculated from this data and found to be in the 1 to 10 hour time range.

The powder mixture milled well and a good mechanically alloyed powder was made. After the final milling cycle, the product powder was removed from the Spex mill and evaluated for particle size and sticking. Samples were also composition analyzed by ICP. The particle sizes attained ranged from <1 micron to about 100 microns maximum. ICP showed the composition to nominally correspond to the charge composition: about 53 wt % Mg and 47 wt % B. The powder was stored in an inert atmosphere glove box to minimize exposure to air. X-ray diffraction showed no evidence of MgB2 formation.

Portions of the resultant Mg—B alloyed powder were incorporated into precursor wires as follows. Cylindrical copper billets were made with OFHC (low oxygen) rod that had been machined to form a deep cavity in each billet. After thorough cleaning and annealing of the billets in an inert atmosphere (2 hours at 600° C. in nitrogen), they were packed with the alloyed precursor powder in one gram increments with an intermediate pressing operation. The billets were nominally ⅝″ OD×5″ long with the cavity being 7/16″ ID and 3.5″ deep. However the actual billet dimensions and billet materials may be varied greatly, and may even include multi cavity forms for directly making multi-filament wires.

After packing, a tail-cap with evacuation stem was welded onto each billet with the billet in a chill mould to prevent reactions from initiating. After evacuation for ½ hour at 100 C., the evacuation stem was crimped and sealed. The billets were then extruded at nominally 250° C. to different sizes. One shape was hexagonal with a flat-to-flat dimension of 0.146″. The extrusion pressure was a low 50,000 pounds per square inch, indicating that extrusion to reductions of up to 300:1 are possible with common presses. Another shape was a 0.25″ diameter rod. Samples of the hexagonal rod were cut up and subjected to structure characterization, reaction and property characterization tests. High quality superconducting MgB2 was found to form at temperatures in the 550° C. to 800° C. range in practical time spans (less than ˜50 hours).

Samples of the above hexagonal wire were also rolled in multiple passes to a final nominal cross-sectional shape of 0.029″ by 0.3″, although further rolling is readily accomplished to produce much thinner dimensions.

Another billet was drawn at ambient temperature via 10% per pass reductions to a final hexagonal shape with a flat-to-flat dimension of 0.07″, although other sizes are also clearly practical. This was accomplished without any anneals, but test showed that anneals of up to 20 minutes at temperatures to 250° C. were sufficient to soften the copper and allow indefinite amounts of ambient temperature drawing without adverse reactions. These drawn and shaped lengths are readily cut into rods, and re-bundled into another billet, followed by sealing and further deformation to form small cross-section round or tape shaped wires (typically 0.1 mm² to about 5 mm² in cross-section). The round wire is also readily twisted about its axis to form low ac loss architectures, particularly in the twist pitch regime of 3 mm to about 20 cm. A sample of this wire was also rolled in multiple passes to produce high aspect ratio precursor tapes, and fully consolidate the precursor material.

Tests were also completed to establish the feasibility of Ta foil lining a copper billet (foil thickness: about 25 microns), followed by powder packing and subsequent processing as described above.

In an alternative alloying process, copper and magnesium are pre-alloyed or pre-reacted to form Cu—Mg intermetallics, followed by milling together the boron and the Cu—Mg intermetallic. These are then put into the copper billets as before, and worked either by extrusion or drawing.

The fraction by volume, or cross-sectional area, of metal matrix in the wires described was in the 40% to 80% range, with the balance being the MgB₂ superconducting material at a density of >95% of the theoretical.

### EXAMPLE 2

This example describes the preparation of a multilayered MgB₂ coated wire. A Nb plated stainless steel wire is used as the coating substrate. A multilayer MgB wire is obtained by depositing multiple layers of boron, followed by reaction with a magnesium vapor. A barrier layer of copper is used between each layer.

A sequence of 10 iterations of boron deposition (at 5 microns thick) using physical vapor deposition (PVD), followed by exposure to Mg vapor at 900° C. is carried out. After each iteration, a non-superconductive layer of copper (Cu) is deposited using PVD.

Those skilled in the art will recognize or be able to ascertain using no more than routine experimentation, many equivalents to the specific embodiments of the invention described specifically herein. For example, while reference has been made above primarily to MgB₂, all these references should be understood to refer to the class of magnesium boride material doped with additional species such as copper, zinc, alkali metals, beryllium and so forth to further enhance the properties.

### EXAMPLE 3

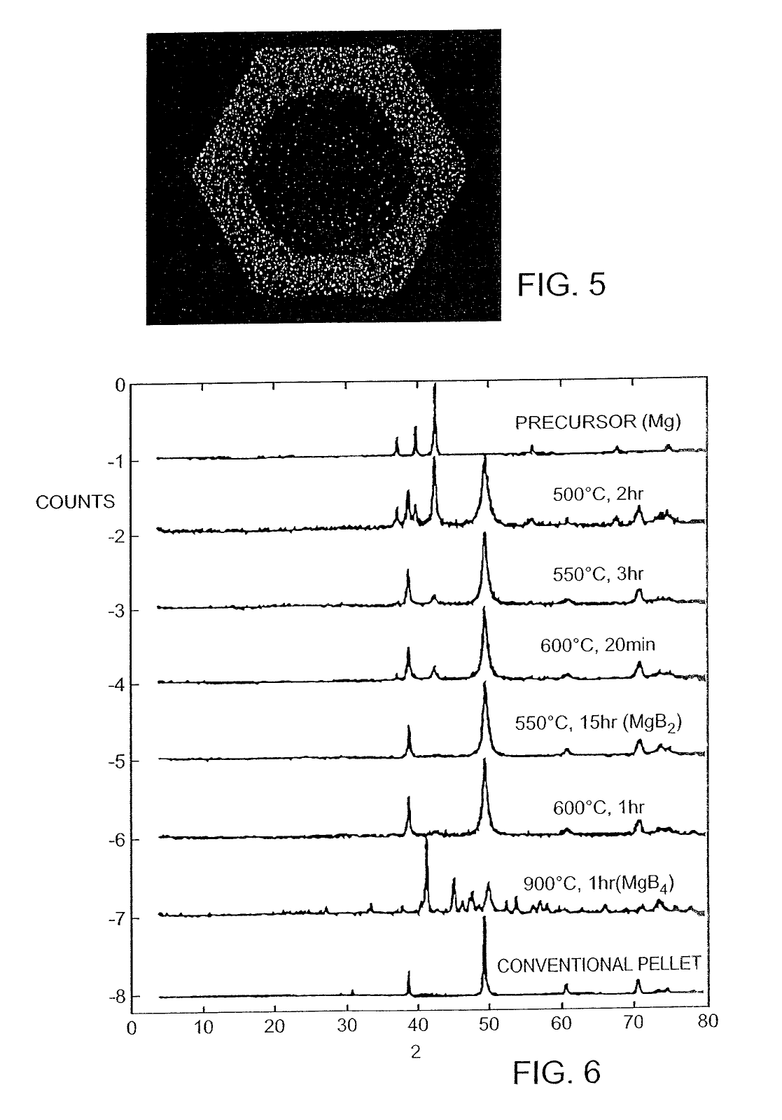

Sample wire made by the method of example 1 with the cross-section shown in FIG. 5 was cut into lengths of 20 to 30 mm. Some had the copper cladding removed mechanically in a lathe, so that the reaction could be studied independently of the copper sheath.

The precursor wire was reacted to form superconducting MgB₂ at 600° or 700° C. in an atmosphere of 5% hydrogen and 95% argon for 1-2 hours. Reaction at higher temperatures (900° C.) resulted in mass loss (28%) and produced an x-ray diffraction pattern consistent with formation of MgB₄. Reaction at lower temperatures resulted in partial conversion to MgB₂ with some Mg still remaining. Measurement of the superconducting critical temperature confirmed the formation of the MgB₂ superconducting phase, however the critical temperatures of the samples (33.5-36.5K) were lower than that reported for pressed pellets reacted at 900° C. (38.5K).

The short-length samples were reacted in an atmosphere of 5% H₂ and 95% argon for periods of time ranging from 20 minutes to 3 hours. It was generally found that when the alloyed materials were reacted under similar conditions to conventional pellets, namely around 900° C., the magnesium-boron material did not react to the desired MgB₂ phase but to MgB₄. Lower temperatures, however, resulted in successful synthesis of MgB₂. FIG. 6 summarizes the results of this example in the form of x-ray diffraction patterns obtained from exposed cores of the wires after reaction. The conditions of temperature and time of reaction are listed for each diffraction trace. The diffraction pattern at the top is for the precursor magnesium-boron alloyed material while the diffraction pattern for a conventional single phase MgB₂ pellet is shown at the bottom. Reaction at 500° C. for 2 hours (trace 2) produced partial conversion to MgB₂. Reaction at 550° C. for 3 hours or at 600° C. for 20 minutes (traces 3 and 4) resulted in a greater conversion to MgB₂. Reaction at 550° C. for 15 hours or 600° C. for 1 hour (traces 5 and 6) resulted in almost complete conversion, with negligible mass loss. Reaction at 900° C. for one hour resulted in complete conversion to MgB₄ and a mass loss of 26%. Reaction at 600° C. for one hour, then ramping to 900° C. and holding for one hour has negligible mass loss and formed pure MgB₂.

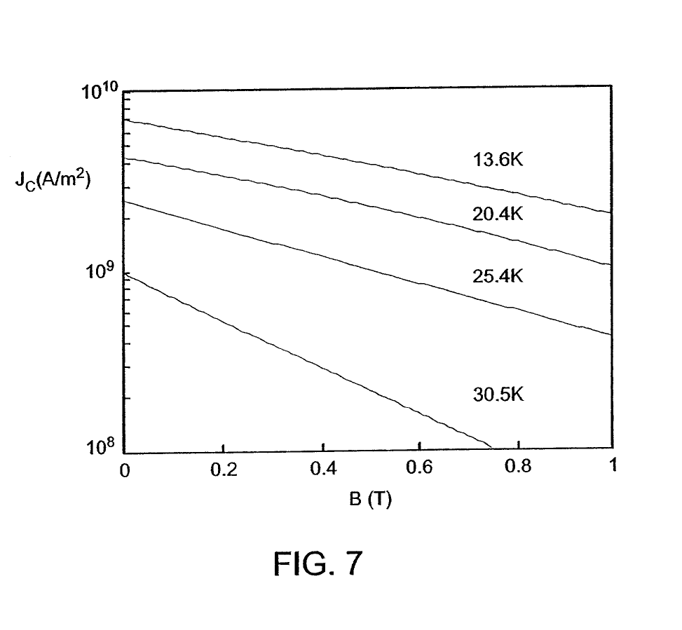

A further short-length sample was reacted at 600° C. in an atmosphere of 5% H₂ and 95% argon for a period of 2 hours. The sample was then investigated in a vibrating-sample magnetometer to determine the magnetization as a function of temperature and magnetic field strength. Using the Bean critical state model and an established numerical fitting procedure the critical current density was determined from this magnetic data. FIG. 7 shows the critical current density, J_{c}, plotted as a function of applied field for various temperatures. The results indicate a J_{c} value of 7×10⁵ A/cm² at 14 K and zero applied magnetic field and 1×10⁵ A/cm² at 20 K and 1 Tesla field. These are significantly better results than those obtained for pressed, sintered pellets.

### EXAMPLE 4

In the examples that follow, a commercially available MgB₂ powder is used to demonstrate the applicability of SPR for MgB₂ tapes.

A Ni 201 bar was machined into a billet with a 0.5″ outside diameter and a 0.34″ internal diameter. Sufficient solid length was left as a drawing nose. A commercially available MgB₂ powder from Alfa Aesar was packed inside the billet in multiple steps, leading to an overall packing density of 65%. All packing was done in a glove box kept under Ar gas. After the packing was completed a lead plug was put on top of the powder column. One end was swaged to provide a drawing nose, while the other end was swaged to keep the lead plug in place. The billet was drawn at 11% per pass using drawing dies with a 18° die angle. Drawing was continued to 0.08″ diameter. The wire was rolled at 10% reduction per pass to a thickness of 0.045″ using a so-called four-high roll stand, with 4″ diameter backing rolls and 1″ diameter work rolls. Wire tension was carefully controlled. Next, the wire was rolled using SPR in a single pass to 0.017″ (62% deformation). A similar wire was rolled using SPR to 0.013″ (71% deformation). Both wires showed homogeneously deformed cross sections with no cracks in the cores. After a heat treatment at 950° C. for 30 minutes to sinter the core, no changes in the core morphology were evident.

### EXAMPLE 5

A similar billet as described in Example 1 was packed, but now with a milled MgB₂ powder. As received, the commercial grade MgB₂ powder is rather coarse and inhomogeneous and milling was used to improve powder packing and powder uniformity. The powder was milled for two hours in a planetary ball mill resulting in a greatly reduced particle size. The billet was packed to 65% packing density, and deformed as in Example 4. This tape showed excellent deformation homogeneity in 0.017 and 0.013″ thick tapes.

### EXAMPLE 6

An Oxide Dispersion Strengthened (ODS) copper billet was machined into a billet with a 0.625″ outside diameter and a 0.5″ internal diameter. As copper tends to react with MgB₂ at temperatures over 700° C., an iron barrier tube was made. Iron is known to be chemically inert towards MgB₂ but otherwise compatible with copper at elevated temperatures. The dimensions of the iron insert tube were 0.5″/0.42″. The billet was packed with the same milled MgB₂ powder as was used in Example 5. The billet was drawn at 11% per pass using the same drawing dies as described in Example 4, to 0.08″ diameter. From thereon, the rolling process followed the same pattern as in Example 4. Here too, the cores were homogeneously deformed at a deformation strain of 61% during SPR.

Those skilled in the art will recognize or be able to ascertain using no more than routine experimentation, many equivalents to the specific embodiments of the invention described specifically herein. For example, while reference has been made above primarily to MgB₂, all these references should be understood to refer to the class of magnesium boride material doped with additional species such as copper, zinc, alkali metals, beryllium and so forth to further enhance the properties. Although various embodiments which incorporate the teachings of the present invention have been shown and described in detail herein, those skilled in the art can readily devise many other varied embodiments that incorporate these teachings.

References cited herein are incorporated in their entirety by reference.

What is claimed is:

1. An superconducting article comprised of one or more elongated metal matrix regions containing one or more embedded elongated superconducting Mg—B regions running the full length of the article, wherein the superconducting Mg—B regions have a density greater than 95% of the theoretical density, and a transition temperature in zero field of 30 K.

2. The superconducting article of claim 1, wherein the Mg—B superconductor comprises approximately 53 weight % Mg and 47 weight % B.

3. The superconducting article of claim 1, wherein the Mg—B superconductor comprises MgB₂.

4. The superconducting article of claim 1, wherein the article is a monofilament.

5. The superconducting article of claim 1, wherein the article is a multifilament.

6. The superconducting article of claim 1, wherein the article is a round wire.

7. The superconducting article of claim 1, wherein the article is an aspected tape.

8. The superconducting article of claim 1, wherein the cross-sectional dimension of the article is in the range of 0.1 mm² to 5 mm².

9. The superconducting article of claim 1, wherein 40% to 80% of the cross-section is comprised of a non-superconducting metal matrix.

10. The superconducting article of claim 1 wherein the metal matrix is comprised of copper or a copper alloy.

11. The superconducting article of claim 1, wherein the metal matrix is selected from the group consisting of stainless steel, oxide dispersion strengthened copper and nickel alloys.

12. The superconducting article of claim 1 with a metal matrix comprised of copper or a copper alloy, and a second metal layer between the Mg—B regions and the copper regions.

13. The superconducting article of claim 12, wherein the second metal layer is a barrier layer.

14. The superconducting article of claim 13, wherein the barrier layer is selected from the group consisting of tantalum, niobium, nickel, nickel alloys, iron, tungsten, molybdenum and combinations thereof.

15. The superconducting article of claim 12, wherein the second metal layer is a high resistivity layer.

16. The superconducting article of claim 15, wherein the resistivity layer is selected from the group consisting of cobalt, manganese, NiTi, and NiZr.

17. The superconducting article of claim 1, wherein the superconducting regions further comprise flux pinning sites.

18. The superconducting article of claim 15, wherein the flux pinning sites are selected from the group consisting of particles of metal diborides, rare earth oxides, boron oxide, MgO, and boron.

19. The superconducting article of claim 1, further comprising a metal laminate on the outer surface of the article.

20. The superconducting article of claim 19, wherein the metal laminate is selected from the group consisting of copper, copper alloys, stainless steel, aluminum, aluminum alloys, and nickel alloys.

21. A method of making a high density Mg—B superconducting article, comprising the steps of:
providing a packed powder sheath, said powder comprising a source of magnesium and boron;
subjecting the packed powder sheath to a symmetric deformation, said deformation selected to elongate the packed powder sheath to form a wire while retaining the free flow of particles within the powder core;
subjecting the wire to high reduction rolling, said high reduction rolling selected to reduce the wire thickness by 40 to 95%; and
heating the rolled article to improve the superconducting properties of the article.

22. The method of claim 21, wherein the powder of the packed powder sheath comprises a mechanically alloyed Mg+B powder.

23. The method of claim 21, wherein the powder of the packed powder sheath comprises a mixture of boron and magnesium.

24. The method of claim 21, wherein the powder of the packed powder sheath comprises MgB₂.

25. The method of claim 21, wherein the particle size of the powder is in the range of 10 nm to 1 micron.

26. The method of claim 21, wherein the Mg—B superconductor further comprises flux pinning sites.

27. The method of claim 21, wherein the sheath is comprised of copper or a copper alloy.

28. The method of claim 21, wherein the packing density of the packed powder sheath is in the range of 35 to 80%.

29. The method of claim 21, wherein the symmetric elongating deformation is selected from the group consisting or wire drawing, extrusion and rod rolling.

30. The method of claim 29, wherein wire drawing is conducted using a die having a total die angle greater than or equal to 14°.

31. The method of claim 30, wherein wire drawing is conducted using a die having a total die angle in the range of 14° to 25°.

32. The method of claim 21, wherein the high reduction rolling reduces thickness in the range of 50 to 75%.

33. The method of claim 21, wherein the high reduction rolling is carried out using large diameter rolls that have a large contact area with the wire.

34. The method of claim 33, wherein the large diameter rolls have a diameter greater than 2 inches.

35. The method of claim 33, wherein the large diameter rolls have a diameter greater than or equal to about 4 inches.

36. The method of claim 21, wherein a low reduction rolling is carried out before the large reduction rolling.

37. The method of claim 36, wherein the low reduction rolling reduces the thickness of the wire by less than 20% per pass.

38. The method of claim 36, wherein the low reduction rolling alters the shape of the wire to provide a geometry that has a larger contact area with the roll in the subsequent high reduction rolling operation.

39. The method of claim 21, wherein the wire prior to high reduction rolling has a geometry is round, oval, square, rectangular or tape-like.

40. The method of claim 21, wherein the heating is carried out to convert a precursor of the Mg—B superconductor into the Mg—B superconductor.

41. The method of claim 21, wherein the heating is carried out to sinter the Mg—B superconductor.
